(19) United States
(12) Patent Application Publication
(10) Pub. No.: US 2022/0200850 A1
(43) Pub. Date: Jun. 23, 2022

(54) MULTIPLE-HOP PEER-TO-PEER NETWORK

(71) Applicant: Intel Corporation, Santa Clara, CA (US)

(72) Inventors: Manish Airy, Bengaluru (IN); Nagarajan Muralidharan, Bangalore (IN); Puneeth Srinivasa, Bengaluru (IN)

(21) Appl. No.: 17/131,448

(22) Filed: Dec. 22, 2020

(51) Int. Cl. H04L 12/24; H04L 29/12; H04B 17/318; H04W 56/00; H04W 48/16; H04L 29/08

(52) U.S. Cl. CPC H04L 41/0806; H04L 61/20; H04B 17/318; H04W 84/12; H04W 48/16; H04L 67/104; H04L 61/6022; H04W 56/001

(57) ABSTRACT

Methods, apparatuses, and computer readable media for a common preamble for wireless local-area networks (WLANs). An apparatus of a first wireless device including processing circuitry configured to decode a first data frame from a second wireless device, the data frame indicating a destination address of a third wireless device and in response to the third wireless device being an immediate neighbor of the first wireless device, encode a second data frame comprising the data from the first data frame and an address of the third wireless device as the receiver address of the data frame. The processing circuitry further configured to in response to the third wireless device not being an immediate neighbor of the first wireless device, encode the second data frame to comprise the data from the first data frame, an address of a fourth wireless device, and the address of the third wireless device.

### TECHNICAL FIELD

Embodiments pertain to wireless networks and wireless communications. Some embodiments relate to peer-to-peer networks (P2P) networks. Some embodiments relate to Wi-Fi Alliance (WFA) Neighbor Awareness Networking (NAN). Some embodiments relate to wireless local area networks (WLANs) including multiple-hop peer-to-peer networks.

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments;

FIG. 2 illustrates FEM circuitry in accordance with some embodiments;

FIG. 3 illustrates radio integrated circuit (IC) circuitry in accordance with some embodiments;

FIG. 4 illustrates a functional block diagram of baseband processing circuitry in accordance with some embodiments;

FIG. 5 illustrates a WLAN in accordance with some embodiments;

FIG. 6 illustrates a block diagram of an example machine upon which any one or more of the techniques (e.g., methodologies) discussed herein may perform;

FIG. 7 illustrates a block diagram of an example wireless device upon which any one or more of the techniques (e.g., methodologies or operations) discussed herein may perform;

FIG. 8 illustrates a peer-to-peer (P2P) network, in accordance with some embodiments;

FIG. 9 illustrates a multiple-hop P2P network, in accordance with some embodiments;

FIG. 10 illustrates discovery windows (DWs), in accordance with some embodiments;

FIG. 11 illustrates an action frame, in accordance with some embodiments;

FIG. 12 illustrates a data frame, in accordance with some embodiments;

FIG. 13 illustrates an architecture for a multiple-hop P2P network, in accordance with some embodiments;

FIG. 14 illustrates a protocol for a multiple-hop P2P network, in accordance with some embodiments;

FIG. 15 illustrates a software architecture for a multiple-hop P2P network, in accordance with some embodiments;

FIG. 16 illustrates a method for a multiple-hop P2P network, in accordance with some embodiments; and

FIG. 17 illustrates a method for a multiple-hop P2P network, in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments relate to methods, computer readable media, and apparatus for ordering or scheduling location measurement reports, traffic indication maps (TIMs), and other information during SPs. Some embodiments relate to methods, computer readable media, and apparatus for extending TIMs. Some embodiments relate to methods, computer readable media, and apparatus for defining SPs during beacon intervals (BI), which may be based on TWTs.

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio-architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, 6 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

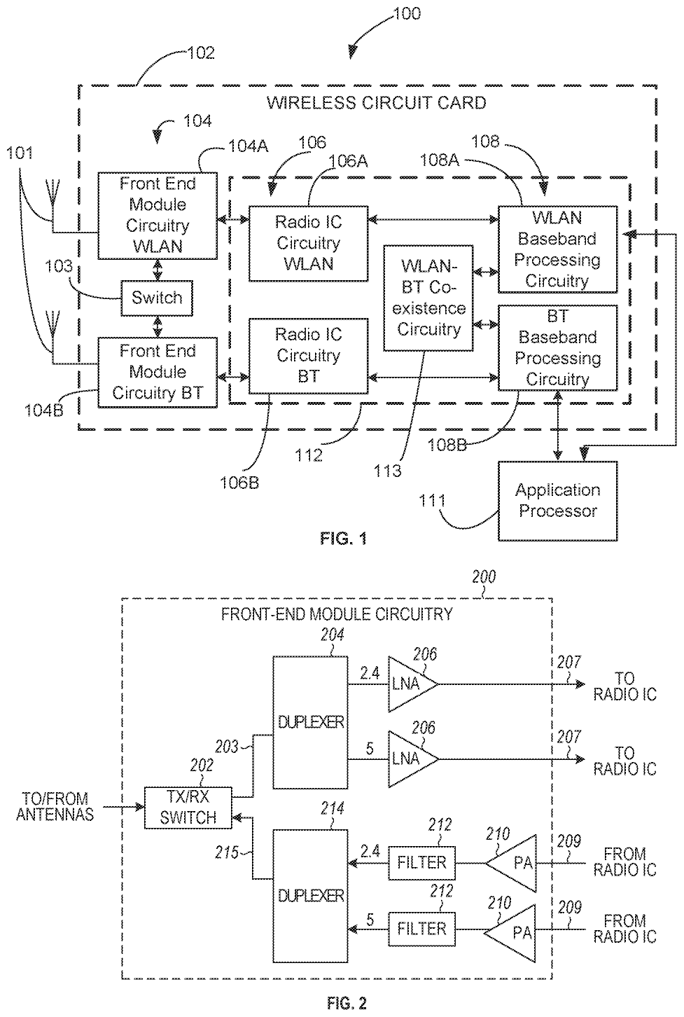

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum, the 5 GHz frequency spectrum, or the 6 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

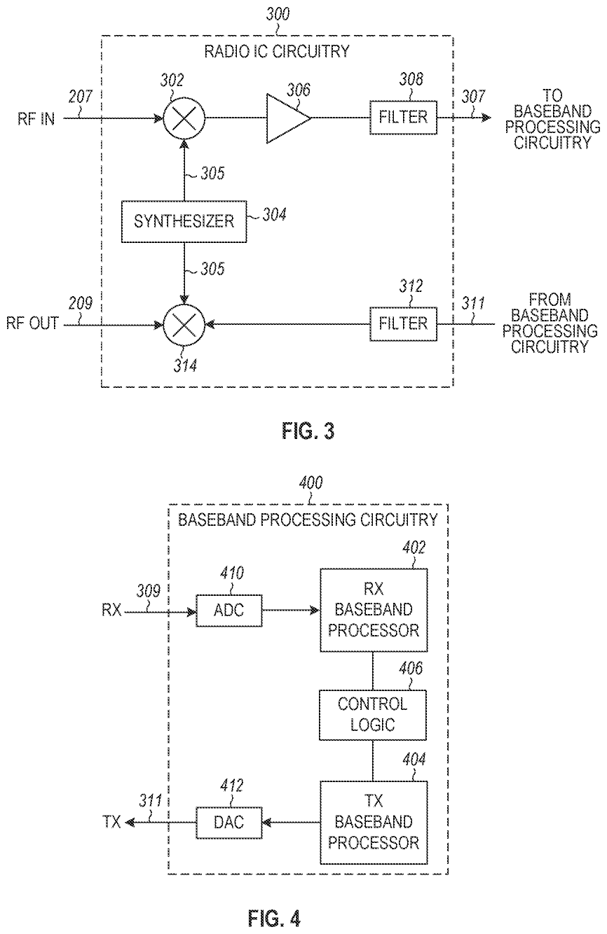

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LIT or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

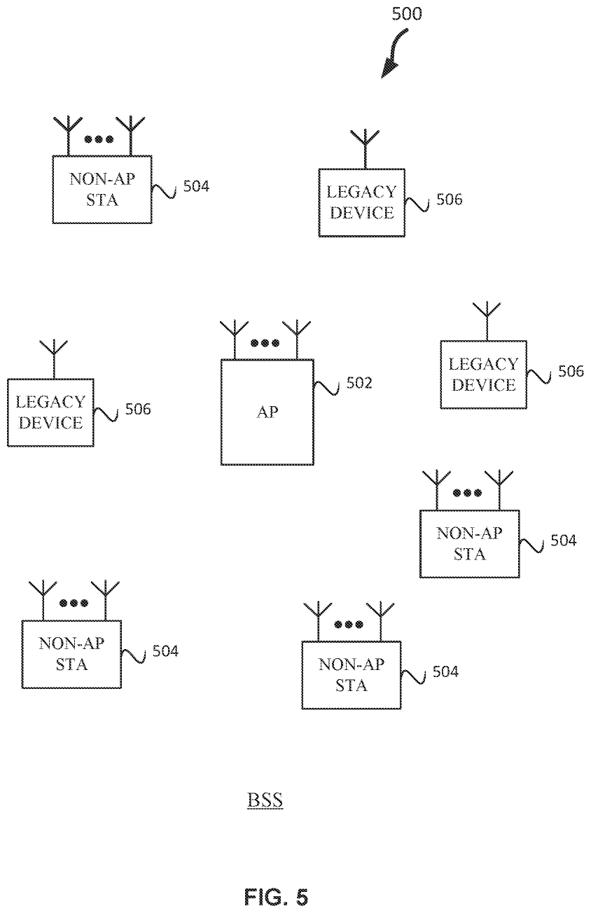

FIG. 5 illustrates a WLAN 500 in accordance with some embodiments. The WLAN 500 may comprise a basis service set (BSS) that may include an access point (AP) 502, which may be termed an AP, a plurality of non-AP stations (STAs) 504 (e.g., IEEE 802.11ax/be/etc.), and a plurality of legacy (e.g., IEEE 802.11g/n/ac/ax) devices 506. In some embodiments, the non-AP STAs 504 and/or AP 502 are configured to operate in accordance with IEEE 802.11 extremely high throughput (EHT). In some embodiments, the non-AP STAs 504 and/or AP 502 are configured to operate in accordance with Network Aware Networking (NAN) and/or WiFi aware. In some embodiments, the non-AP STAs 504 and/or AP 520 are configured to operate in accordance with IEEE 802.11az. In some embodiments, the AP 502 may be configured to operate a EHT BSS, HE BSS, and/or a BSS. Legacy devices may not be able to operate in the EHT BSS and beacon frames in the EHT BSS may be transmitted using EHT PPDU's. An non-legacy BSS may use non-legacy PPDUs to transmit the beacon frames and legacy devices 506 may not be able to decode the beacon frames and thus are not able to operate in an non-legacy BSS. The BSSs, e.g., BSS, EHT BSS, non-legacy BSS, and HE BSS, may use different BSS identifications (IDs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may be IEEE 802.11ax/be. The IEEE 802.11 protocol may be IEEE 802.11 next generation or another non-legacy name. The EHT protocol may be termed a different name in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502 and may control more than one BSS, e.g., assign primary channels, colors, etc. AP 502 may be connected to the internet.

The legacy devices 506 may operate in accordance with one or more of IEEE 802.11 a/b/g/n/ac/ad/af/ah/aj/ay/ax, or another legacy wireless communication standard. The legacy devices 506 may be STAs or IEEE STAs. In some embodiments, when the AP 502 and non-AP STAs 504 are configured to operate in accordance with IEEE 802.11EHT, the legacy devices 506 may include devices that are configured to operate in accordance with IEEE 802.11ax. The non-AP STAs 504 may be wireless transmit and receive devices such as cellular telephone, portable electronic wireless communication devices, smart telephone, handheld wireless device, wireless glasses, wireless watch, wireless personal device, tablet, internet of things (IoTs) or another device that may be transmitting and receiving using the IEEE 802.11 protocol such as IEEE 802.11EHT or another wireless protocol. In some embodiments, the non-AP STAs 504 may be termed extremely high throughput (EHT) stations or stations.

The AP 502 may communicate with legacy devices 506 in accordance with legacy IEEE 802.11 communication techniques. In example embodiments, the AP 502 may also be configured to communicate with non-AP STAs 504 in accordance with legacy IEEE 802.11 communication techniques.

In some embodiments, a protocol such a NAN, HE, and/or EHT frame may be configurable to have the same bandwidth as a channel. The protocol, NAN, HE, EHT frame may be a physical Layer Convergence Procedure (PLCP) Protocol Data Unit (PPDU). In some embodiments, there may be different types of PPDUs that may have different fields and different physical layers and/or different media access control (MAC) layers. For example, a single user (SU) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 2.5 MHz, 5 MHz, 10 MHz, 20 MHz, 40 MHz, or 80 MHz, 80+80 MHz, 160 MHz, 160+160 MHz, 320 MHz, 320+320 MHz, 640 MHz, or more, bandwidths. In some embodiments, the bandwidth of a channel less than 20 MHz may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced with the channel. In some embodiments the bandwidth of the channels is 256 tones per 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A non-legacy protocol, NAN, HE, and/or EHT frame may be configured for transmitting a number of spatial streams, which may be in accordance with MU-MIMO and may be in accordance with OFDMA. The AP 502 and/or non-AP STAs 504 may be configured for one or more of the following: multi-band, multi-stream operation, and QAM such as 4096 QAM or another number. In other embodiments, the EHT AP 502, EHT STA 504, and/or legacy device 506 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, low-power BlueTooth®, or other technologies.

In accordance with some IEEE 802.11 embodiments, e.g, IEEE 802.11EHT/ax embodiments, an AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous uplink (IT) transmissions from non-AP STAs 504. The AP 502 may transmit a time duration of the TXOP and sub-channel information. During the TXOP, non-AP STAs 504 may communicate with the EHT AP 502 in accordance with a non-contention based multiple access technique such as OFDMA or MU-MIMO. This is unlike conventional WLAN communications in which devices communicate in accordance with a contention-based communication technique, rather than a multiple access technique. During the non-legacy, HE, or EHT control period, the AP 502 may communicate with non-AP stations 504 using one or more non-legacy, HE, or EHT frames. During the TXOP, the non-AP STAs 504 may operate on a sub-channel smaller than the operating range of the AP 502. During the TXOP, legacy stations refrain from communicating. The legacy stations may need to receive the communication from the AP 502 to defer from communicating.

In accordance with some embodiments, during the TXOP the non-AP STAs 504 may contend for the wireless medium with the legacy devices 506 being excluded from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy stations 506 and/or non-AP stations 504 in accordance with legacy IEEE 802.11 communication techniques. In some embodiments, the AP 502 may also be configurable to communicate with non-AP stations 504 outside the HE TXOP in accordance with legacy IEEE 802.11 or IEEE 802.11EHT/ax communication techniques, although this is not a requirement.

In some embodiments the non-AP stations 504 may be a “group owner” (GO) for peer-to-peer modes of operation. A wireless device may be termed a non-AP station 502 or an AP 502. In some embodiments, the non-AP STAs 504 and/or AP 502 may be configured to operate in accordance with IEEE 802.11mc. In example embodiments, the radio architecture of FIG. 1 is configured to implement the non-AP STA 504 and/or the AP 502. In example embodiments, the front-end module circuitry of FIG. 2 is configured to implement the non-AP STA 504 and/or the AP 502. In example embodiments, the radio IC circuitry of FIG. 3 is configured to implement the non-AP stations 504 and/or the AP 502. In example embodiments, the base-band processing circuitry of FIG. 4 is configured to implement the non-AP station 504 and/or the AP 502.

In example embodiments, the non-AP stations 504, AP 502, an apparatus of the non-AP stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4. In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-17.

In example embodiments, the non-AP station 504 and/or the AP 502 are configured to perform the methods and operations/functions described herein in conjunction with FIGS. 1-17. In example embodiments, an apparatus of the non-AP station 504 and/or an apparatus of the AP 502 are configured to perform the methods and functions described herein in conjunction with FIGS. 1-17. The term Wi-Fi may refer to one or more of the IEEE 802.11 communication standards. AP and STA may refer to AP 502 and/or non-AP station 504 as well as legacy devices 506.

In some embodiments, a HE AP STA may refer to a EHT AP and/or a EHT STAs that is operating as a HE APs. In some embodiments, when a non-AP STA 504 is not operating as a HE AP, it is referred to as a non-AP STA or non-AP. In some embodiments, the non-AP STAs 504 and/or APs 502 are operating in a peer-to-peer (P2P) network such as NAN and may implement one or of the other protocols disclosed herein.

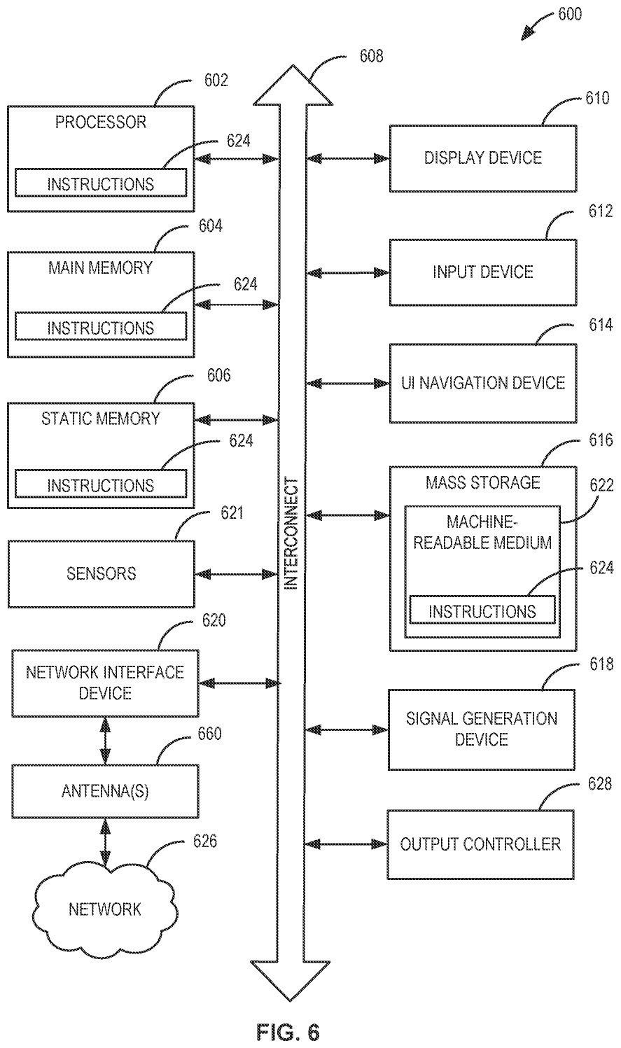

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a AP 502, non-AP station 504, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UI navigation device 614, a mass storage 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

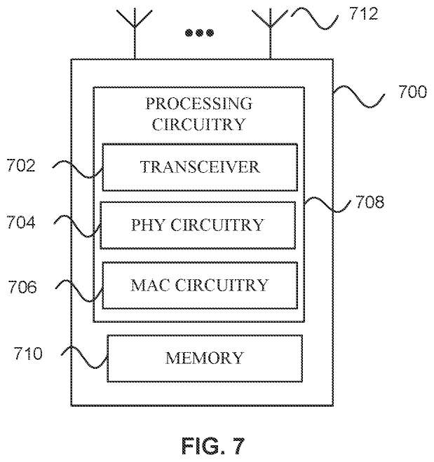

FIG. 7 illustrates a block diagram of an example wireless device 700 upon which any one or more of the techniques (e.g., methodologies or operations) discussed herein may perform. The wireless device 700 may be a HE device or HE wireless device. The wireless device 700 may be a EHT STA 504, EHT AP 502, and/or a HE STA or HE AP. A EHT STA 504, EHT AP 502, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., EHT AP 502, EHT STA 504, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610, input device 612, etc.) Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., EHT AP 502 and/or EHT STA 504), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TXOP and encode or decode an HE PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a HE PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mmWave technology, communication between a station (e.g., the EHT stations 504 of FIG. 5 or wireless device 700) and an access point (e.g., the EHT AP 502 of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

A technical problem in IEEE 802.11 is how to integrate a new generation with the old generations. A new amendment often requires new SIG fields that include information to support new physical (PHY)/media access control (MAC) features for the new amendment. The new SIGs are placed after the L-SIG field so that legacy device 506 will decode the L-SIG and determine a length of the PPDU or packet and defer from transmitting for a time based on the length. When new SIG fields have been defined in a new amendment, for example the IEEE 802.11ax HE-SIG-A, only devices that support IEEE 802.11ax and any follow-on amendments (e.g. IEEE 802.11be) can decode the information in the HE-SIG-A field. Pre-IEEE 802.11ax devices (e.g. legacy device 506) are not able to decode later generation SIG field as they do not know the format to decode the later generation SIG field, e.g., HE-SIG-A or EHT-SIG. However, some of the information (e.g., BSS color, TxOP duration, bandwidth) in later generation SIGs (e.g., HE-SIGA or EHT-SIG) needs to be signaled in future amendments for coexistence, e.g., intra-physical layer (PHY) protocol data unit (PPDU) PPDU power save.

Some embodiments improve coexistence among different IEEE 802.11 STAs EHT STAs 504 and HE STAs) and therefore improve overall network efficiency and enable power saying. For example, in some embodiments, intra-PPDU power saving and spatial reuse are improved by providing a common preamble with a common SIG field that also may reduce detection and classification of PPDUs.

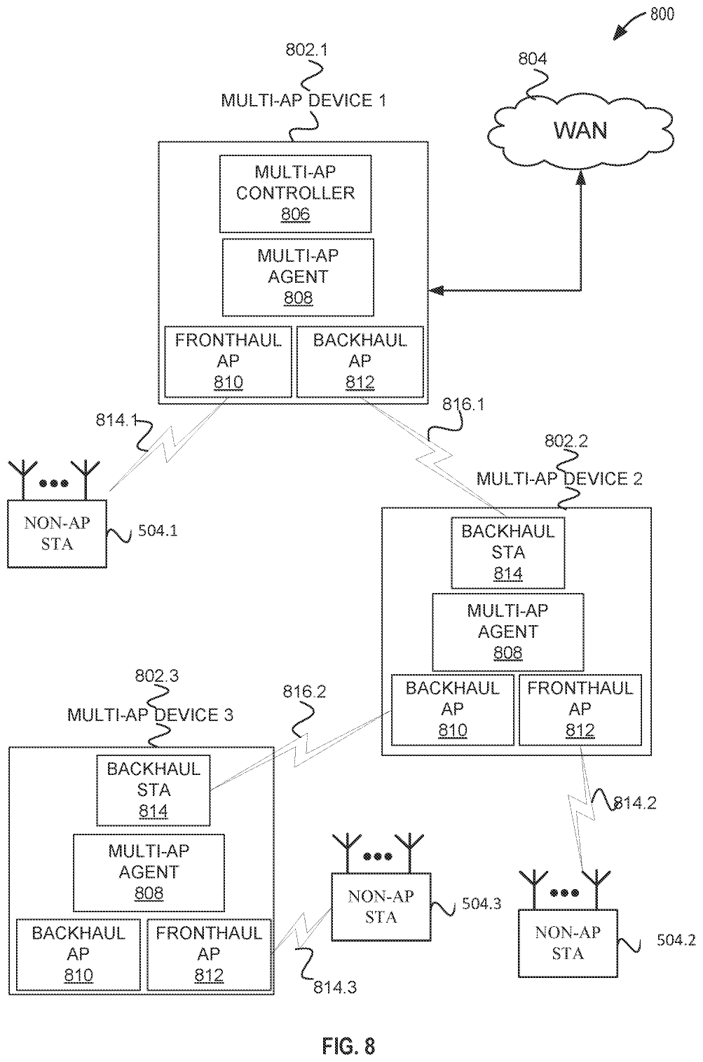

FIG. 8 illustrates a peer-to-peer (P2P) network 800, in accordance with some embodiments. The multiple AP (multi-AP) devices 802 are APs 502, in accordance with some embodiments. The multi-AP devices 802 may include one or more APs. The multiple-AP devices 802 are configured to operate in accordance with NAN and IEEE 802.11, in accordance with some embodiments. Multi-AP devices 802 may be termed infrastructure APs. Multi-AP device 1 802.1 may be termed a gateway since it is connected to the wide-area network (WAN) 804, which may provide access to the internet and/or other networks. The multi-AP device 802.1 and 802.2 may be termed repeaters since traffic may be routed through them to the multi-AP device 802.1. In some embodiments, the multi-AP devices 802 may take on a role as a “master” AP or a “slave” or “non-master” AP.

The multiple-AP devices 802 may bridge the communications 814 between other multi-AP devices 802, non-AP STAs 504, and the wide-area network (WAN) 804. The communications 814 are between a multi-AP device 802 and the non-AP STAs 504. The communications 814 may require multiple hops. For example, communication 814.3 may be a communication with an entity in the WAN 804. The multi-AP device 3 802.3 receives the communication 814.3 and forwards or transmits it to multi-AP device 2 802.2 via backhaul communication 816.2. The multi-AP device 2 802.2 forwards or transmits the communication 814.3 to multi-AP device 1 802.1 via backhaul communication 816.1. Multi-AP device 1 802.1 then forwards or sends communication 814.3 to WAN 804. In this way, communication 814.3 may be communicated between the WAN 804 and non-AP STA 504.3. Similarly, communications from the WAN 804 are forwarded to the non-AP STA 504.3.

The multiple-AP devices 802 may include one or more of a multi-AP controller 806, multi-AP agent 808, fronthaul AP 810, backhaul AP 812, backhaul STA 814, and backhaul AP 810. The multiple-AP device 802.1 provide services to the non-AP STAs 504. The non-AP STAs 504 forward communications 814 through the multi-AP devices 802 to transfer data to another multi-AP device 802, another AP STA 504, or to/from the WAN 804. For a first non-AP STA 504 to transmit data to a second non-AP STA 504 at least twice as much bandwidth is used since the data must be sent to a multi-AP device 802 and then be re-transmitted by the same multi-AP device 802 or forwarded to another multi-AP device 802 and then transmitted to the second non-AP STA 504.

For example, non-AP STA 504.3 may be associated with multi-AP device 3 802.3 via fronthaul AP 812 and be part of a BSS 500 with multi-AP device 3 802.3 acting as the AP 502 as described in FIG. 5. Non-AP STA 504.3 transfers data via fronthaul communication 814.3 to multi-AP device 3 802.3 that sends or transmits the data via backhaul communication 816.2 to multi-AP device 2 802.2, which transmits the data to non-AP STA 504.2 via fronthaul communication 814.2. Non-AP STA 504.2 may be associated with a BSS 500 with multi-AP device 2 802.2 acting as the AP 502. So, for non-AP STA 504.3 to transfer data to non-AP STA 504.2, the data was transmitted in communication 814.3, backhaul 816.2, and communication 814.2. Non-AP STA 504,3 exchanges data with the WAN 804 via multi-AP device 3 802.3, multi-AP device 2 802.2, and multi-AP device 3 802.1 via backhaul communications 816.1 and 816.2.

In some embodiments, non-AP STA 504.2 and non-AP STA 504.3 may communicate directly using WiFi direct or NAN. When operating in accordance with WiFi direct or NAN, if non-AP STA 504.3 wants to communicate with non-AP STA 504.1 and is out of communication range of non-AP STA 504.1, then non-AP STA 504.3 has to go through multi-AP device 2 802.2 and multi-AP device 1 802.1. Additionally, non-AP STA 504.3 will have to associate with multi-AP device 3 802.3, which may require onboarding, discovery, configuration, channel selection, capability reporting, link metric reporting, backhaul optimization, client steering, and so forth. Associate may mean to become part of a BSS 500 with multi-AP device 3 802.3 acting as the AP 502 as described in conjunction with FIG. 5. Onboarding includes a new client such as a non-AP STA 504 using a preset configuration to gain Layer 2 connectivity with a multi-AP device 802. In some embodiments, when operating in accordance with WiFi direct or NAN, a discovery phase includes a new device establishing its role as a “master” or “slave (or non-master)” such as either a non-AP STA 504 or an AP 502, respectfully.

Configuration includes a new client receiving configuration information from the AP 502 such as a service set (SS) identification (ID)(SSID). Channel selection includes coordinated channel selection to minimize co-channel interference. Capability reporting includes an AP 502 transmitting capabilities to the non-AP STA 504 and the non-AP STA 504 reporting capabilities to the AP 502. Link metric reporting includes quantifying the link capability between APs 502. Backhaul optimization includes providing robust links between the APs 502, e.g., multi-AP devices 802, to get to the WAN 804. Client steering includes positioning the non-AP STA 504 to the appropriate AP 502. All of these operations to enable non-AP STA 504.3 and non-AP STA 504.2 to exchange data require many transmissions.

In some embodiments, multi-AP device 2 802.1, 802.2, and 802.3 use a three (3) address mode when communicating in fronthaul communications 814 and a four (4) address mode when communicating in backhaul communications 816.

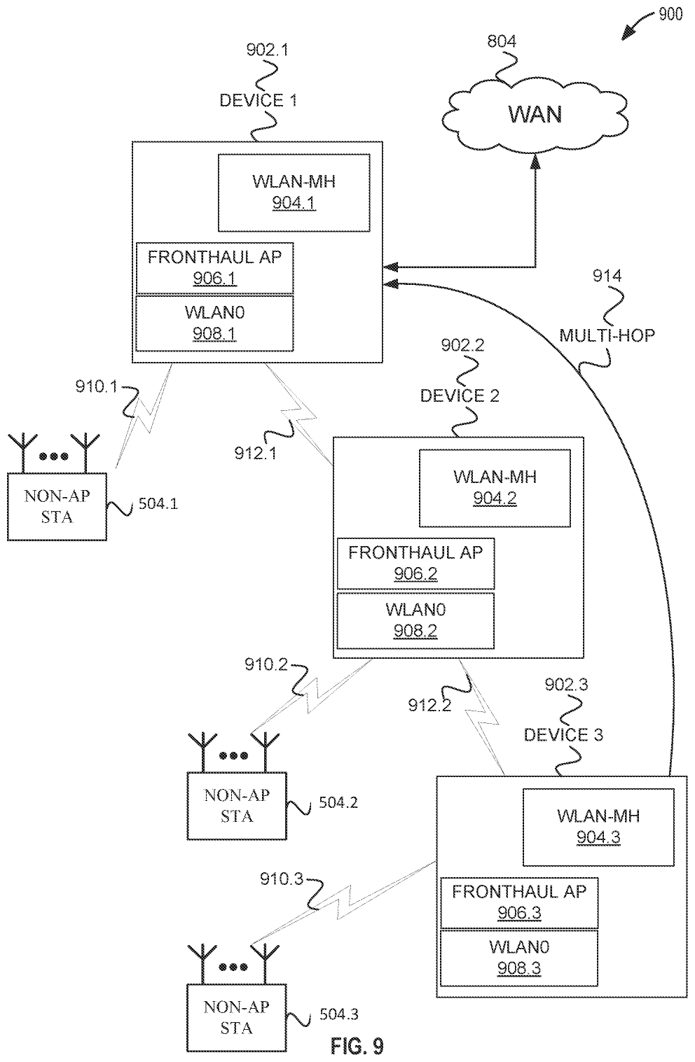

FIG. 9 illustrates a multiple-hop P2P network 900, in accordance with some embodiments. Illustrated in FIG. 9 is device 1 902.1, device 2 902.2, device 3 902.3, WAN 804, non-AP STAs 504.1, 504.2, 504.3, legacy communications 910.1, 910.2, 910.3, and multiple hops P2P communications 912.1, 912.2. Each of device 1 902.1, device 2 902.2, and device 3 902.3 may be either an AP 502 or a non-AP STA 504. The wireless local area network (WLAN) multi-hop (MH) interfaces (WLAN-MH) 904.1, 904.2, 904.3 implement the protocol for the multiple hops P2P network, in accordance with some embodiments. The multiple hops P2P communications 912.1, 912.2 are the communications as described herein that are part of the multiple hops P2P protocol. The multiple-hop 914 is comprised of multiple hops P2P communications 912.1, 912.2.

The fronthaul AP 906 and WLAN0 908 are configured to implement other protocols such as legacy protocols. The non-AP STA 504.1 is communicating using legacy communications 910.1 with device 1 902.1. For example, device 1 902.1, device 2 902.2, and device 3 902.3 may be APs 502 and the non-AP STA 504.1, 504.2, 504.3 may be associated with the respective AP and communicating using IEEE 802.11be or another protocol.

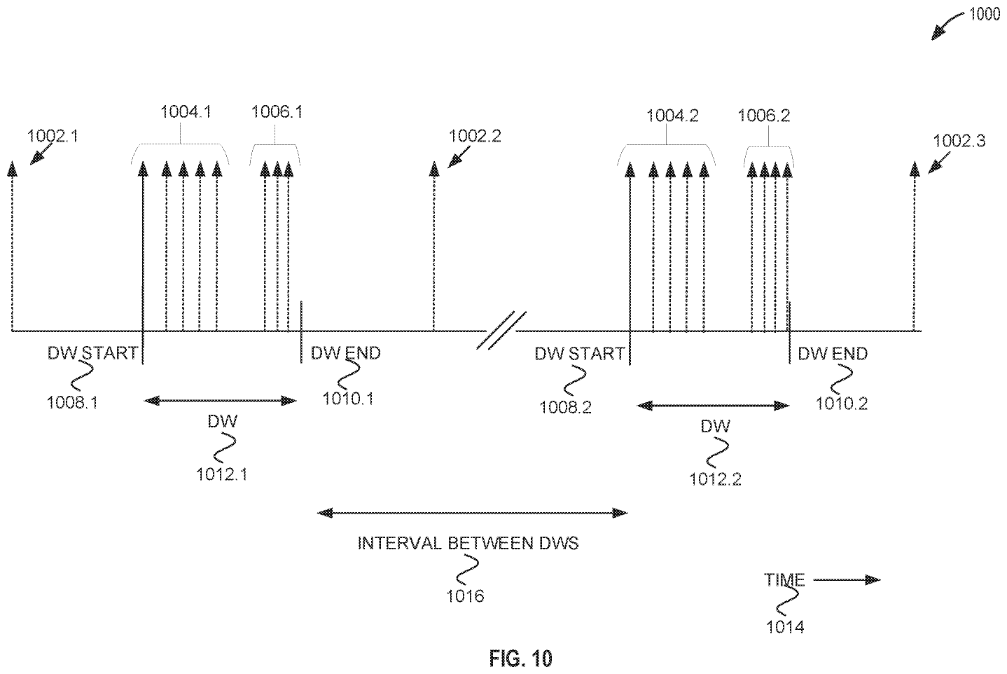

FIGS. 10-13 are disclosed in conjunction with FIG. 9. FIG. 10 illustrates discovery windows (DWs) 1000, in accordance with some embodiments. Illustrated in FIG. 10 is time 1014 along a horizontal axis and DWs 1012. The vertical axis indicates frequency. The DW start 1008.1 and 1008.2 and DW end 1010.1 and 1010.2 indicate the start and end of DWs 1012.1, 1012.2, respectively. The interval between DWs 1016 indicates the interval between DWs 1012.1 and DW 1012.2. The discovery beacons 1002.1, 1002.2, 1002.3 may be transmitted by one of the devices 902 that takes the role of a master device in accordance with the multi-hop P2P protocol and/or another protocol such as NAN. Synchronization beacons 1004.1, 1004.2 and service discovery frames 1006.1, 1006.2 are transmitted by the devices 902. The devices 902 may transmit the discovery beacons 1002, synchronization beacons 1004, and/or service discovery frames 1006 in accordance with the multi-hop P2P protocol and/or another protocol such as NAN.

In some embodiments, the devices 902 are configured to operate with the DWs 1012 within a same channel such as channel 6 in the 2.4 GHz band, channel 33 in the 5 GHz band, or a channel in the 6 GHz band. In some embodiments, the devices 902 are configured to operate in accordance with NAN and the multi-hop P2P protocol.

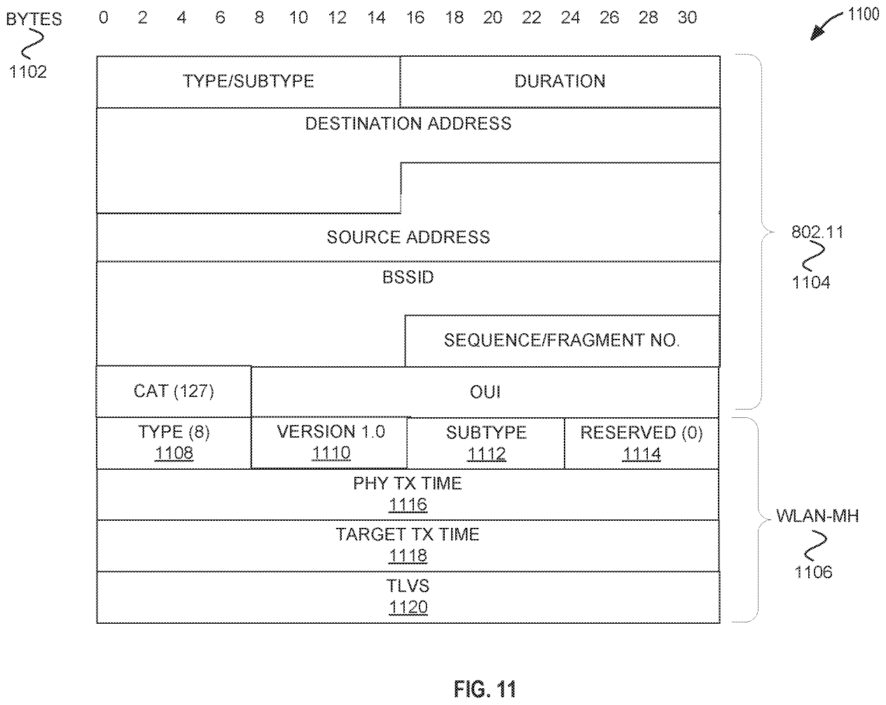

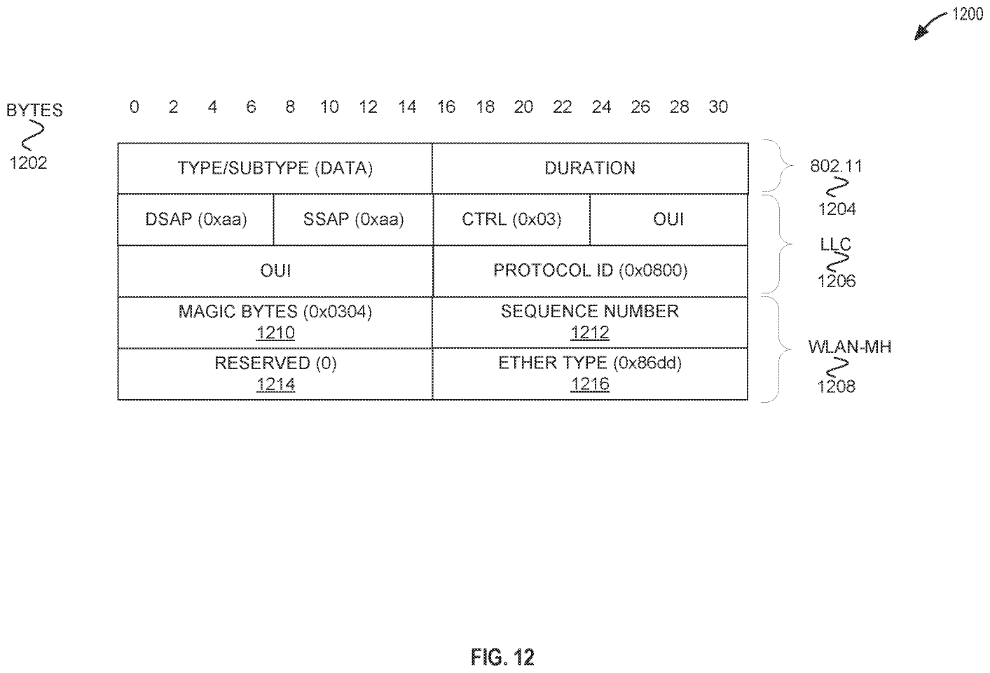

FIG. 11 illustrates an action frame 1100, in accordance with some embodiments. FIG. 12 illustrates a data frame 1200, in accordance with some embodiments. The devices 902 are configured to encode, decode, receive, and transmit action frames 1100 and data frames 1200, in accordance with the multi-hop P2P protocol. The action frame 1100 includes an IEEE 802.11 (802.11) portion and WLAN-MH 1106 portion. The data frame format 1200 includes an 802.11 portion 1204, a logical link control (LLC) portion 1206, and a WLAN-MH 1208 portion. The WLAN-MH 1106 portion includes type/length/value (TLV)s 1120, physical (PHY) transmit (TX) time 1116 and target TX time 1118, which may be in μ seconds. The TLVs 1120 may be where subfields indicate a type, a length subfield indicating a length of the overall field, and a value field with the value for the field. For example, for a synchronization tree 1314, the TLVs 1120 may include a type subfield that indicates a synchronization tree, a length field that indicates the length of data for the synchronization field, and then a value field that indicates the data of the synchronization tree.

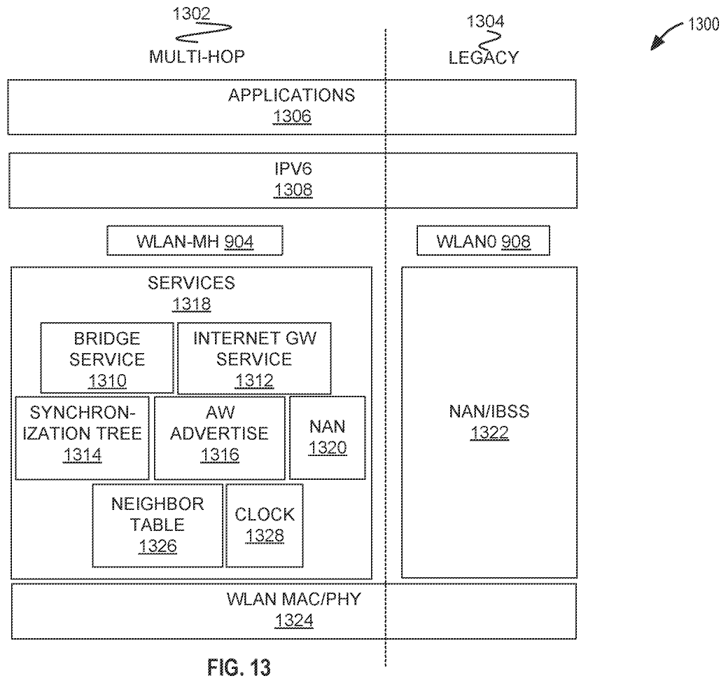

FIG. 13 illustrates an architecture 1300 for a multiple-hop P2P network, in accordance with some embodiments. The architecture 1300 includes the WLAN-MH 904 and WLAN0 908. The WLAN-MH 904 may include services 1318 and a portion of WLAN MAC/PHY 1324. The services 1318 includes one or more of: bridge service 1310, internet gateway (GW) service 1312, synchronization tree 1314, AW advertise 1316, and NAN 1320 or another P2P protocol, neighbor table 1326, and clock 1328. The devices 902 may operate in accordance the architecture 1300.

The WLAN-MH 904 of FIGS. 9 and 13 may monitor the channel used for the DWs 1012. The fronthaul AP 906 and WLAN0 908 may use a different channel for legacy communications 910.1, 910,2, 910.3. For example, referring to FIG. 13, the WLAN-MH 904 may use a first channel when transmitting and receiving for services 1318 and a second channel for WLAN0 908 transmitting and receiving for NAN/BSS 1322. WLAN-MH 904 and WLAN0 908 may share the WLAN MAC/PHY 1324 layer.

The AW advertise 1316 is storage of AW advertisements that neighboring devices have transmitted. The device 902 uses the AW advertise 1316 to determine a matching time and channel when the device 902 can transmit to a neighboring device. The NAN 1320 indicates that the services 1318 may include NAN 1320 services as well as the services and protocols of the multi-hop P2P protocol disclosed herein. In some embodiments, NAN 1320 services are used for clock synchronization and for DWs 1012. For example, the packet formats may be used from NAN 1320 and the default durations and times may be used from NAN 1320. The neighbor table 1326 stores the addresses of devices 902 that have advertised services along with the RSSIs recorded from receiving frames from the devices 902. The devices 902 use the neighbor table 1326 to determine which device 902 to transmit a frame to for a service. In some embodiments, the neighbor table 1326 is transmitted as part of a service or discovery frame and the neighbor tables 1326 of other devices 902 is stored in the neighbor table 1326 and used for making routing decisions. The clock 1328 indicates a clock 1328 time for synchronization with other devices that are using the multi-hop P2P protocol disclosed herein. If the device 902 is acting as the master node, then the clock 1328 may be a clock time of the device 902.

Referring back to FIGS. 9 and 10, the devices 902 may transmit discovery beacons 1002, synchronization beacons 1004, and service discovery frames 1006. For example, the multiple hops P2P communications 912.1 and 912.2 may be discovery beacons 1002, synchronization beacons 1004, and service discovery frames 1006.

Referring to FIG. 10, the service discovery frames 1006 includes internet GW service 1312, which announces that the device 902 is connected to a WAN 804 or another connection. The service discovery frames 1006 further include bridge service 1310, which announces that the device 902 will bridge data to a neighbor device 902 or node. The devices 902 may be termed nodes or master nodes within a mesh network. The services may be extensions of “WiFi aware functionality” or NAN. In some embodiments, the services may be termed WiFi mesh functionality.

The devices 902 are configured to provide the bridge service 1310 to enable multi-hop operation. For example, multi-hop 914 may be a communication from device 3 902.3 to device 1 902.1 via device 2 902.2, which may be communicated via first multiple hops P2P communication 912.1 and then multiple hops P2P communication 912.2. Device 2 902.2 may provide the bridge service.

The devices 902 are configured to monitor the service discovery frames 1006 to look for a device 902 that provides the internet GW service 1312. The device 902 that provides the internet GW service 1312 may be termed a master node. The devices 902 are configured to provide the bridge service 1310. The devices 902 determine a route to send a packet based on signal strength such as received signal strength indicator (RSSI) values. The devices 902 are configured to drop frames when the RSSI value is below a threshold value, which may be termed an “edge synchronization” threshold. A higher value of the edge synchronization threshold provides more reliable for applications 1306 such as Internet of Things (IoT), robotics, and gaming. A lower edge synchronization threshold provides connectivity for applications that need a greater range such as networking for file transfers including multicast/broadcast/unicast services. In some embodiments, frames from the device 902 acting as the master node may be accepted with a lower threshold than the edge synchronization threshold. In some embodiments the edge synchronization threshold may be determined based on the application that generated the packets such as a gaming application or file transfer application.

The devices 902 are configured to build a synchronization tree 1314 as a master routing table, which may be used to determine routing for the bridging service 1310. The devices 902 may support synchronization where a device 902 acting as a master node may exchange frames to synchronize. The devices 902 may be configured to form a cluster that are synchronized to a common clock of the master node. A timing synchronization function (TSF) may keep all the timers of the devices 902 synchronized. The devices 902 may be configured to transmit beacon frames for synchronizing timers. In some embodiments the devices 902 are configured to perform discovery of one another to form a WLAN-MH 904 cluster.

In some embodiments, the devices 902 are configured to encode, decode, transmit, and receive frames such as the action 1100 and data frames 1200 in plain text without authentication. In some embodiments, the MAC address used by the devices 902 is randomized. In some embodiments, the devices 902 are configured for a single-sign-on (SSO) for authentication.

When a device 902 needs a new operation channel for the WLAN-MH 904 interface, the device 902 gains control of the channel periodically such as 50 ms out of the 100 ms. To switch to another channel the device 902 transmits a clear-to-send to self (CTS2self), a quiet information element (IF), or a broadcast target wake time (TWT) to silence the use of the channel by the WLAN0 908 interfaces and other devices that may be using the channel. The discovery channels 6 and 44 of 2.4 GHz band (or other channels may be used) are used for coordination using the periodic synchronization frames (PSFs). A device 902 monitors one or more channels to discover other devices 902 that are acting as nodes. Whether another device 902 is within range or not may be based on the RSSI threshold. If a first device 902 is acting as a master node and an action frame 1100 is received that indicates that a second device 902 is also acting as the master node, the first device 902 can determine to permit the second device 902 to act as the master node. If no frames are received, the device 902 assumes the master node as part of the Internet GW service 1312.

The device 902 acting as the master node is configured to transmit a “clock signal”. The devices 802 acting as non-master nodes may be termed slave nodes and will adopt to the clock signal of the master node. For example, the clock signal may be used for a common network time reference for purposes of available windows and other uses. With only two devices 802 one will be a master node and one will be a slave node. The slave nodes may repeat the clock signal of the master node in one of the frames disclosed herein.

The devices 802 when acting as slave nodes may be more than one hop away from the master node. The devices 802 may act as intermediate slave nodes that are configured to perform functions of a bridge service 1310 and may repeat the clock signal from the master node. In the synchronization tree 1314 the nodes that are acting as intermediate slave nodes or non-election master are indicated as such in the synchronization tree. The devices 802 are configured to announce the path to the master node and to use this information to construct the synchronization tree 1314. The device 802 may perform a breadth first search or a similar search to find a path from the device 802 to the master node when the device 802 is not the master node and is not directly in communication with the master node.

The wlan0 908 interface uses IEEE 802.11 vendor-specific action frames, in accordance with some embodiments. Referring to FIG. 11, in some embodiments, in an action frame 1100, a to-distribution system (DS) flag and from-DS flag are set to zero and the following three address fields are used: the destination address, source address, and BSS identification. One or more of the fronthaul AP 906, WLAN0 908 interface, and WLAN-MH 904 may use the three-address format. In some embodiments, the WLAN0 908 interface, and WLAN-MH 904 interface use an IEEE 802.11 vendor-specific action frame format header for user data, which use the BSSID as an organization unique identifier (OUI). The GU is a 24 bit address that uniquely identities an organization, vendor, or manufacturer, in accordance with some embodiments.

The devices 802 are configured to broadcast a channel sequence type/length/value (TLV) listing its availability windows (AWs) in a frame such as an action frame 1100. For example, the devices 802 may broadcast the TLV listing its AWs as a discovery beacon 1002, as a synchronization beacon 1004 and/or as a service discovery frame 1006. The action frame format 1100 and/or data frame 1200 may include TLVs 1120, which may include the TLV listing its AWs. The type 1108, version 1110, and subtype 1112 may indicate the type of frame, version of the protocol, and subtype of frame.

An AW field indicates when the device 902 is available for data and the data channel of availability. Other devices 902 match the TLV listing, which may be termed advertisements, with their own AWs. If there is a common channel in a particular AW, communication during this AW is possible.

Channel hopping sequence is adapted according to the current outgoing traffic load. When a first device 902 transmits user data, e.g., application 1306 data, to a second device 902, the first device 902 needs to determine the AWs during which both nodes are tuned to the same channel and only transmit frames during those AWs. In some embodiments, the second device 902 will transmit an ACK frame to indicate that the frame was received.

Each device 902 constructs a link-local IPv6 address based on the 48-bit MAC address of the network interface, in accordance with some embodiments. For example, if o0:o1:o2:o3:o4:o5 is a 48-bit MAC address of a device 902, the corresponding linklocal IPv6 address is constructed as: fe:80::o0\hat{ }0x02:o1:o2:ff:fe:o3:o4:o5. Devices 902 add their neighboring devices 902 to the neighbor table or synchronization tree 1314 using the linklocal IPv6 address after receiving the first frame from that device 902. In some embodiments, the devices 902 do not need additional address resolution protocols such as neighbor discovery protocol (NDP) or address resolution protocol (ARP) because the linklocal iPv6 address is sufficient for decoding and encoding frames.

The WLAN-MH 904 is configured to provide mesh connectivity services that are advertised in service discovery frames 1006. The mesh connectivity services extend the WiFi Aware functionality to WiFi Mesh Functionality. When a device 902 is connected to a wired broadband, then the device 902 advertises the internet gateway (GW) service. In some embodiments, the device 902 announces the internet GW service based on a different type of connection such as a wireless connection or a connection based on light.

A device 902 announces a bridge Service, which indicates the device 902 is acting as a node and will bridge data to a node that advertises the internet GW service 1312 or to another bridge node. A node receiving data to bridge uses the synchronization tree 1314 to determine which node to transmit the data to for the internet GW service 1312 or to reach another node. The bridge node may determine an AW between the node to transmit the data and itself and then transmit a data frame 1200 to the node during the AW. The receiving node may transmit an ACK frame to indicate that it has successfully received the data frame 1200. The bridge node may retransmit the data frame 1200 if it does not receive an ACK frame or it may determine to transmit the data frame 1200 to another bridge node or master node, in accordance with some embodiments.

A device 902 makes routing decisions in the following manner, in accordance with some embodiments. The device 902 determines routing based on the RSSI values from receiving the action frames 1200 or other frames. A device 902 may filter out nodes when the connection is unstable. For example, nodes drop frames when the RSSI is below an edge sync threshold which, in some embodiments, is set to −65 dBm. In some embodiments, the edge sync threshold is configurable to a predetermined value. In some embodiments, the edge sync threshold is advertised such as in a service discovery frames 1006 and may be set by the master node.

Frames from the current master node may be accepted with a lower RSSI than the edge sync threshold, in accordance with some embodiments. The synchronization tree TLV 1314 also serves as a master routing table and is used to set up bridging. The devices 902 are configured to encode action frames 1100 and data frames 1200 in plain-text and without authentication, in accordance with some embodiments. The MAC address randomization is enabled, in accordance with some embodiments. The devices 902 may be configured to perform security functions in the transport and/or application layer such as transport layer security TLS 1.2 or another version. The devices 902 may be configured to use single-sign-on (SSO) or equivalent as a one-time authentication.

Referring to FIG. 13, the legacy 1304 portion indicates that the architecture 1300 may support both legacy 1304 and multi-hop 1302 protocols. Applications 1306 indicates applications such as Internet of Things (IoT), robotics, gaming, internet browsing, accessing office applications, and so forth. IPV6 1308 indicates the addressing is IPV6 1308, in accordance with some embodiments.

In some embodiments, the synchronization tree 1314 is a list of nodes that are near to the node building the synchronization tree 1314 based on an RSSI of a frame or packet received from the other node. The nodes advertise their synchronization tree with an indication of whether a node is a master node or whether or another node has a path to a master node. In some embodiments, the nodes advertise their synchronization tree 1314 with more than one hop from the node. For example, the synchronization tree 1314 may include a path to a master node.

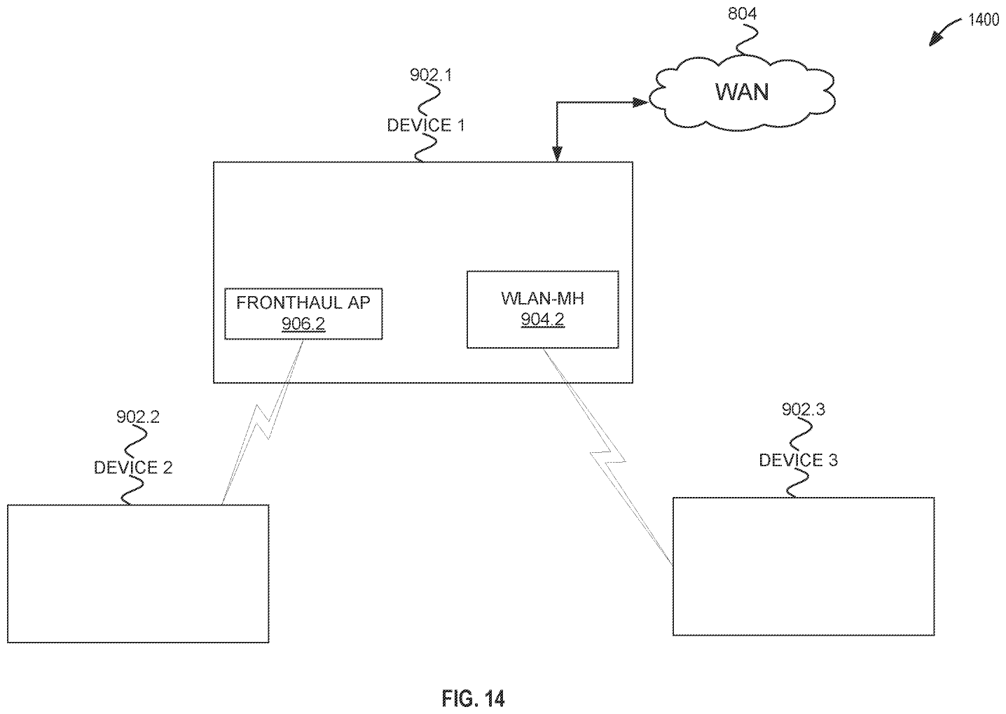

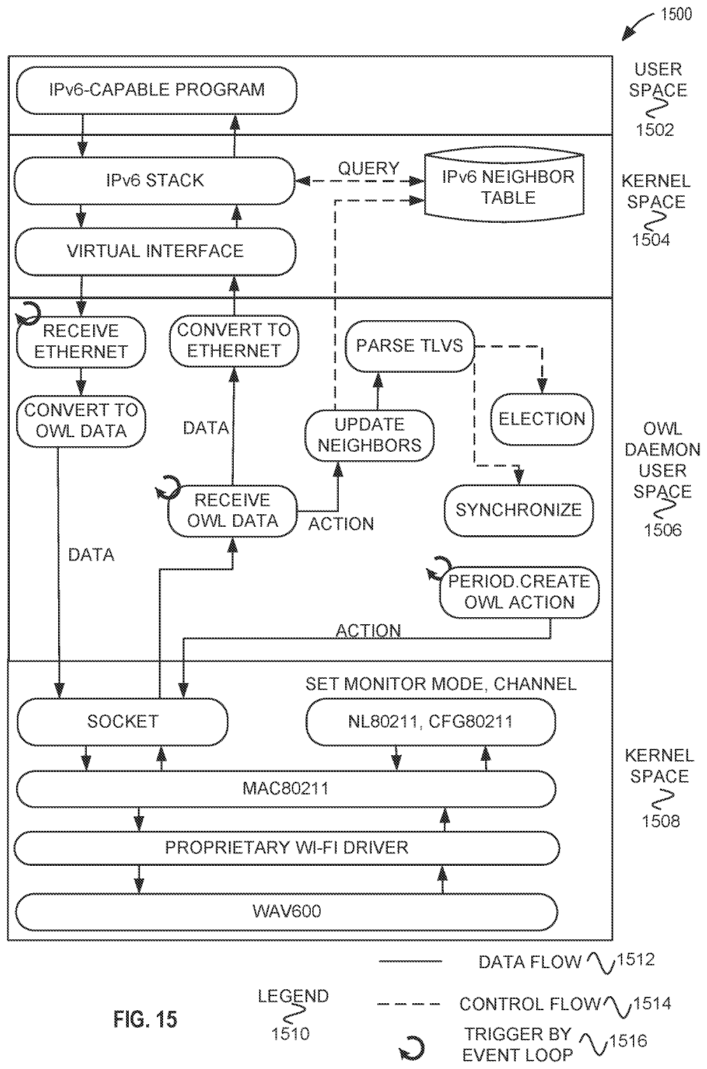

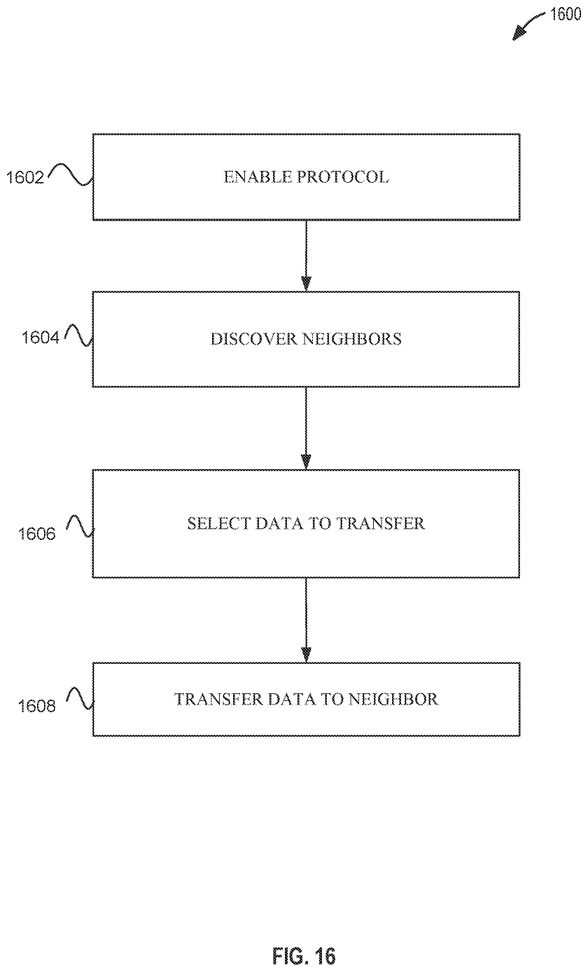

FIGS. 14-16 are disclosed in conjunction with one another. FIG. 14 illustrates a protocol 1400 for a multiple hops P2P network, in accordance with some embodiments. FIG. 15 illustrates a software architecture 1500 for a multiple-hop P2P network, in accordance with some embodiments. FIG. 16 illustrates a method 1600 for a multiple-hop P2P network, in accordance with some embodiments. Illustrated in FIG. 14 is device 1 902.1, device 2 902.2, device 3 902.3, and WAN 804, which may be the same or similar as disclosed in FIGS. 8 and 9. For a prototype, device 1 902.1 was a personal computer (PC) running Linux® with support for WLANs, device 2 902.2 was a laptop computer with support for WLAN, and device 3 902.3 was a portable phone with Open Wireless Link (OWL) based on a wireless direct link (WDL), which is based on NAN 2.0.

In the prototype, each of the devices 902 ran a prototype of WLAN-MH 904. A proprietary OUI was used based on OWL. The IWNL network has three devices. In the prototype, files were successfully exchanged among the devices 902 and between the devices 902 and the WAN 804.

The devices 902 concurrently used 3GPP, NAN, IEEE 802.11, and WLAN-MH 904. The fronthaul AP 906, WLAN0 908, and WLAN-MH 904 all operated concurrently. A device 902 may act as a non-AP STA 504 and connect on WLAN0 908 and use the WLAN-MH 904 interface or protocol. The devices 902 may set-up a NAN P2P and use the WLAN-MH 904 interface or protocol.

A demo application for file transfer was used and ping was used, The action frame 1100 does not need association with an AP 502. Data frames 1200 transmitted to a known BSSID with a unique MAC source address triggers a wireless distribution system (WDS) P2P connection.

Illustrated in FIG. 15 is user space 1502, kernel space, 1504, OWL daemon user space 1506, and kernel space 1508. The legend 1510 indicates a data flow 1512, control flow 1514, and triggered by event loop 1516. In some embodiments architecture 1500 is for a WLAN-MH 904. The kernel space 1504, 1508 is similar to a legacy WLAN AP with modification for WLAN-MH 904.

The WiFi Aware functionalities are provided from on Open Wireless Link, which is similar to WiFi Aware. In the prototype data transfers were demonstrated. For example, a data transfer with concurrent pings between device 2 and device 1 902.1, and between device 3 902.3 and device 1 902.1 with device 1 902.1 having both the WLAN0 908 and WLAN-MH 904 interfaces. In another example, a file transfer between device 1 902.1 and device 3 902.3 is performed. The pings between device 2 902.2 and device 1 902.1, and device 1 902.1 and device 3 902.3 may be displayed on a screen of device 1 902.1 with both the WLAN0 908 and WLAN-MH 904 interfaces.

FIG. 16 illustrates a method 1600 of multiple-hop P2P network, in accordance with some embodiments. The method 1600 begins with enable protocol 1602. For example, there may be a menu selection option in a device 902 for enabling and disabling the WLAN-MH 904 interface or enabling or disabling the WLAN-MH 904 may be automatic or performed by an application.

The method 1600 continues with discovering neighbors. For example, a file transfer session setup may include a sender initiating the discovery procedure by emitting its hashed contact identifiers in a frame such as in an action frame 1100 in a discovery frame 1006 during a DW 1012. The sender and receiver are devices 902. The receiver compares the sender's contact hashes with identifiers in its own address book if set to contacts only mode. If there is at least one contact match or if the receiver is in everyone mode, move to authentication phase. For each discovered service, the sender establishes an HTTPS connection with the receiver and performs a full authentication handshake. If authentication is successful, the sender can transfer the actual file,

The method 1600 continues at operation 1606 with selecting data to transfer. For example, a user or device 902 may select a data file to transfer to its neighbor. The method 1600 continues at operation 1608 with transferring data to a neighbor 1608. For example, the sender may determine a common time when based on a common AW and transmit data frames 1200 to the receiver. Method 1600 may include one or more additional operations. The operations of method 1600 may be performed in a different order. One or more of the operations of method 1600 may be optional.

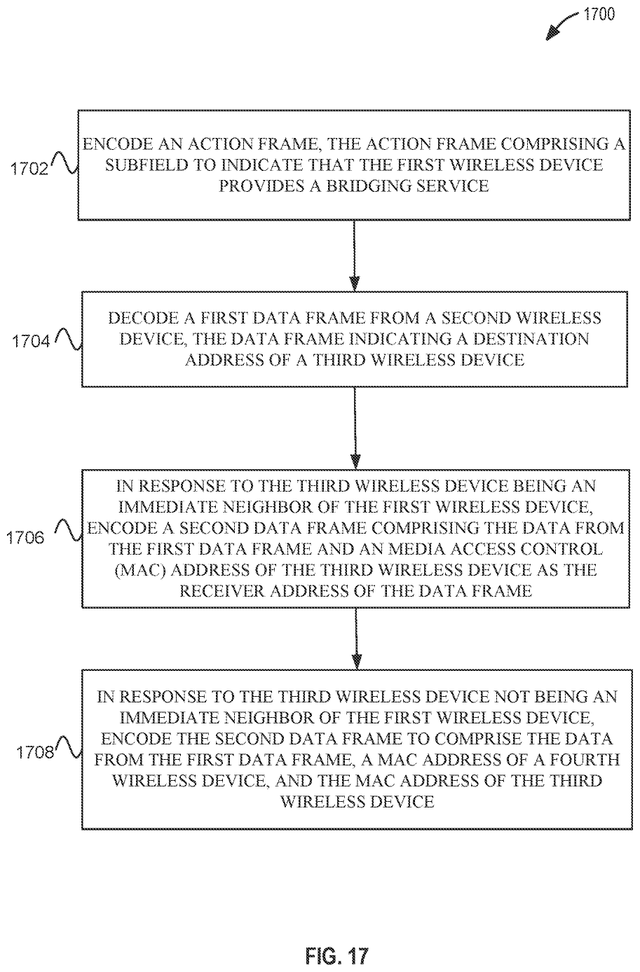

FIG. 17 illustrates a method 1700 of a multiple-hop P2P network, in accordance with some embodiments. The method may be performed by an apparatus of a non-AP STA 504 and/or an AP 502. The method 1700 begins at operation 1704 with encoding an action frame, the action frame comprising a subfield to indicate that the first wireless device provides a bridging service. Operation 1704 may include configuring the first wireless device to transmit the action frame. For example, device 902 may encode and transit an action frame 1100 that indicates the device 902 offers the bridging service.

The method 1700 continues at operation 1704 with decoding a first data frame from a second wireless device, the data frame indicating a destination address of a third wireless device. For example, device 902.3 may receive a frame with an address of device 2 902.2 or device 1 902.1.

The method 1700 continues at operation 1706 with in response to the third wireless device being an immediate neighbor of the first wireless device, encode a second data frame comprising the data from the first data frame and an MAC address of the third wireless device as the receiver address of the data frame. For example, the MAC address may be of device 2 902.2 so that device 3 902.3 encodes a data frame 1200 addressed to device 2 902.2 and transmit it to device 2 902.2.

The method 1700 continues at operation 1708 with in response to the third wireless device not being an immediate neighbor of the first wireless device, encoding the second data frame to comprise the data from the first data frame, a MAC address of a fourth wireless device, and the MAC address of the third wireless device. Operations 1706 and 1708 may include configuring the first wireless device to transmit the second data frame. For example, device 3 902.3 encodes a data frame 1200 with a receiver address for device 2 902.2 and a destination address of device 1 902.1.

Method 1700 may include one or more additional operations. The operations of method 1700 may be performed in a different order. One or more of the operations of method 1700 may be optional.

Example 1 is an apparatus of a first wireless device, the apparatus comprising memory; and processing circuitry coupled to the memory, the processing circuity configured to: encode an action frame, the action frame comprising a subfield to indicate that the first wireless device provides a bridging service; configure the first wireless device to transmit the action frame; decode a first data frame from a second wireless device, the data frame indicating a destination address of a third wireless device; in response to the third wireless device being an immediate neighbor of the first wireless device, encode a second data frame comprising the data from the first data frame and an media access control (MAC) address of the third wireless device as the receiver address of the data frame; in response to the third wireless device not being an immediate neighbor of the first wireless device, encode the second data frame to comprise the data from the first data frame, a MAC address of a fourth wireless device, and the MAC address of the third wireless device; and configure the first wireless device to transmit the second data frame.

In Example 2, the subject matter of Example undefined includes, where the processing circuitry is further configured to: determine whether the third wireless device is the immediate neighbor based on a neighbor table, the neighbor table indicating media access control (MAC) addresses and received signal strength indicators (RSSIs) of wireless devices from which the first wireless device has received a frame.

In Example 3, the subject matter of Examples 1-2 includes, where the processing circuitry is further configured to: determine the fourth wireless device based on the neighbor table, where the neighbor table indicates that the fourth wireless device is a neighbor of the third wireless device,

In Example 4, the subject matter of Examples 1-3 includes, where the processing circuitry is further configured to: determine a common availability window for the first wireless device and the fourth wireless device or the third wireless device based on a received availability window from the third wireless device or the fourth wireless device and availability windows of the first wireless device, the common availability window comprising a channel and time when both the first wireless device and the third wireless device or the fourth wireless device are available to transmit and receive on the channel.

In Example 5, the subject matter of Examples 1-4 includes, where the configure the first wireless device to transmit the action frame further comprises configure the first wireless device to transmit the action frame on a channel, where the channel is channel 6 in the 2.4 GHz band, channel 33 in the 5 GHz band, or a channel in the 6 GHz band.

In Example 6, the subject matter of Example 5 includes, where before the configure the first wireless device to transmit the action frame, the processing circuitry is further configured to: contend for the channel during a discovery window; and gain access to the channel.

In Example 7, the subject matter of Example 6 includes, decode a synchronization beacon from a fifth wireless device, the synchronization beacon comprising an indication of a time of a clock. In Example 8, the subject matter of Example 7 includes, determining the discovery window based on the time of the clock.

In Example 9, the subject matter of Example 8 includes, where the fifth wireless device is a master node connected to wide area network (WAN) or the fifth wireless device is a repeater node repeating a synchronization beacon from the master node.

In Example 10, the subject matter of Example 9 includes, where the synchronization beacon is a first synchronization beacon, and where the processing circuitry is further configured to: determine based on a neighbor table whether to act as a repeater node; and in response to a determination to act as a repeater node, encode a second synchronization beacon comprising a second indication of the time of the clock, where the second indication of the time of the clock is based on the first indication of the time of the dock.

In Example 11, the subject matter of Examples 1-10 includes, where the processing circuitry is further configured to: determine a link local address for the first wireless device; and encode the action frame to comprise the link local address as a transmitter address.

In Example 12, the subject matter of Example 11 includes, 48-bit media access control (MAC) address of the first wireless device and addresses reserved for link local addressing.

In Example 13, the subject matter of Examples 1-12 includes, where the action frame is a first action frame, and where the processing circuitry is further configured to: encode a second action comprising a synchronization tree, the synchronization tree indicating a path from the first wireless device to a master node, where the synchronization tree is encoded using a type, a length, and a value format; and configure the first wireless device to transmit the second action frame.

In Example 14, the subject matter of Examples 1-13 includes, where the action frame is a first action frame and where the processing circuitry is further configured to: in response to a determination that the first wireless device has access to a wide area network (WAN), encode a second action frame, the second action frame comprising a subfield indicting it is a service discover frame and a subfield to indicate that the first wireless device provides an internet gateway (GW) service, configure the first wireless device to transmit the second action frame, and encode a synchronization beacon comprising an indication of a time of a clock of the first wireless device.

In Example 15, the subject matter of Example 14 includes, where the processing circuitry is further configured to: configure the first wireless device to transmit the synchronization beacon at a time based on a discovery window, where the discovery window begins at the transmission of the synchronization beacon.

In Example 16, the subject matter of Examples 1-15 includes, and where the action frame is a physical (PHY) protocol data unit (PPDU).

Example 17 is a non-transitory computer-readable storage medium that stores instructions for execution by one or more processors of an apparatus of a first wireless device, the instructions to configure the one or more processors to: encode an action frame, the action frame comprising a subfield indicating it is a service discovery frame, and a subfield to indicate that the first wireless device provides a bridge service; configure the first wireless device to transmit the action frame; decode a first data frame from a second wireless device, the data frame indicating a destination address of a third wireless device; in response to the third wireless device being an immediate neighbor of the first wireless device, encode a second data frame comprising the data from the first data frame and an media access control (MAC) address of the third wireless device as the receiver address of the data frame; in response to the third wireless device not being an immediate neighbor of the first wireless device, encode the second data frame to comprise the data from the first data frame, a MAC address of a fourth wireless device, and the MAC address of the third wireless device; and configure the first wireless device to transmit the second data frame.

In Example 18, the subject matter of Example 17 includes, where the instruction further configured the one or more processors to: determine whether the third wireless device is the immediate neighbor based on a neighbor table, the neighbor table indicating media access control (MAC) addresses and received signal strength indicators (RSSIs) of wireless devices from which the first wireless device has received a frame.

Example 19 is a method performed by an apparatus of a first wireless, the method comprising: encoding an action frame, the action frame comprising a subfield indicating it is a service discovery frame, and a subfield to indicate that the first wireless device provides a bridge service; configuring the first wireless device to transmit the action frame; decoding a first data frame from a second wireless device, the data frame indicating a destination address of a third wireless device; in response to the third wireless device being an immediate neighbor of the first wireless device, encoding a second data frame comprising the data from the first data frame and an media access control (MAC) address of the third wireless device as the receiver address of the data frame; in response to the third wireless device not being an immediate neighbor of the first wireless device, encoding the second data frame to comprise the data from the first data frame, a MAC address of a fourth wireless device, and the MAC address of the third wireless device; and configuring the first wireless device to transmit the second data frame.

In Example 20, the subject matter of Example 19 includes, determining whether the third wireless device is the immediate neighbor based on a neighbor table, the neighbor table indicating media access control (MAC) addresses and received signal strength indicators (RSSIs) of wireless devices from which the first wireless device has received a frame.

Example 21 is an apparatus of a first wireless device, the apparatus comprising: means for encoding an action frame, the action frame comprising a subfield to indicate that the first wireless device provides a bridging service; means for configuring the first wireless device to transmit the action frame; means for decoding a first data frame from a second wireless device, the data frame indicating a destination address of a third wireless device; in response to the third wireless device being an immediate neighbor of the first wireless device, means for encoding a second data frame comprising the data from the first data frame and an media access control (MAC) address of the third wireless device as the receiver address of the data frame; in response to the third wireless device not being an immediate neighbor of the first wireless device, means for encoding the second data frame to comprise the data from the first data frame, a MAC address of a fourth wireless device, and the MAC address of the third wireless device; and means for configuring the first wireless device to transmit the second data frame.

In Example 22, the subject matter of Example 21 includes, means for determining whether the third wireless device is the immediate neighbor based on a neighbor table, the neighbor table indicating media access control (MAC) addresses and received signal strength indicators (RSSIs) of wireless devices from which the first wireless device has received a frame. In Example 23, the subject matter of Examples 21-22 includes, means for determining the fourth wireless device based on the neighbor table, where the neighbor table indicates that the fourth wireless device is a neighbor of the third wireless device.

In Example 24, the subject matter of Examples 21-23 includes, means for determining a common availability window for the first wireless device and the fourth wireless device or the third wireless device based on a received availability window from the third wireless device or the fourth wireless device and availability windows of the first wireless device, the common availability window comprising a channel and time when both the first wireless device and the third wireless device or the fourth wireless device are available to transmit and receive on the channel.

In Example 25, the subject matter of Examples 21-24 includes where the configure the first wireless device to transmit the action frame further comprises configure the first wireless device to transmit the action frame on a channel, where the channel is channel 6 in the 2.4 GHz band, channel 33 in the 5 GHz band, or a channel in the 6 GHz band.

In Example 26, the subject matter of Example 25 includes, means for contending for the channel during a discovery window; and means for gaining access to the channel. In Example 27, the subject matter of Examples 6-26 includes, means for decoding a synchronization beacon from a fifth wireless device, the synchronization beacon comprising an indication of a time of a clock.

In Example 28, the subject matter of Example 27 includes, means for determining the discovery window based on the time of the clock.

In Example 29, the subject matter of Example 28 includes, where the fifth wireless device is a master node connected to wide area network (WAN) or the fifth wireless device is a repeater node repeating a synchronization beacon from the master node.

In Example 30, the subject matter of Example 29 includes, where the synchronization beacon is a first synchronization beacon, and further comprising: means for determining based on a neighbor table whether to act as a repeater node; and in response to a determination to act as a repeater node, means for encoding a second synchronization beacon comprising a second indication of the time of the clock, where the second indication of the time of the clock is based on the first indication of the time of the clock.

In Example 31, the subject matter of Examples 21-30 includes, means for determining a link local address for the first wireless device; and means for encoding the action frame to comprise the link local address as a transmitter address.

In Example 32, the subject matter of Example 31 includes, 48-bit media access control (MAC) address of the first wireless device and addresses reserved for link local addressing.

In Example 33, the subject matter of Examples 21-32 includes, where the action frame is a first action frame, and further comprising: means for encoding a second action comprising a synchronization tree, the synchronization tree indicating a path from the first wireless device to a master node, where the synchronization tree is encoded using a type, a length, and a value format; and means for encoding configuring the first wireless device to transmit the second action frame.

In Example 34, the subject matter of Examples 21-33 includes, where the action frame is a first action frame and further comprising: in response to a determination that the first wireless device has access to a wide area network (WAN), means for encoding a second action frame, the second action frame comprising a subfield indicting it is a service discover frame and a subfield to indicate that the first wireless device provides an internet gateway (GW) service, configuring the first wireless device to transmit the second action frame, and encoding a synchronization beacon comprising an indication of a time of a clock of the first wireless device.

In Example 35, the subject matter of Example 34 includes, means for configuring the first wireless device to transmit the synchronization beacon at a time based on a discovery window, where the discovery window begins at the transmission of the synchronization beacon. In Example 36, the subject matter of Examples 21-35 includes, and where the action frame is a physical (PHY) protocol data unit (PPDU).

Example 37 is at least one machine-readable medium including instructions that, when executed by processing circuitry, cause the processing circuitry to perform operations to implement of any of Examples 1-36.

Example 38 is an apparatus comprising means to implement of any of Examples 1-36. Example 39 is a system to implement of any of Examples 1-36. Example 40 is a method to implement of any of Examples 1-36.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a first wireless device, the apparatus comprising memory; and processing circuitry coupled to the memory, the processing circuity configured to:
encode an action frame, the action frame comprising a subfield to indicate that the first wireless device provides a bridging service;
configure the first wireless device to transmit the action frame;
decode a first data frame from a second wireless device, the data frame indicating a destination address of a third wireless device;
in response to the third wireless device being an immediate neighbor of the first wireless device, encode a second data frame comprising the data from the first data frame and an media access control (MAC) address of the third wireless device as the receiver address of the data frame;
in response to the third wireless device not being an immediate neighbor of the first wireless device, encode the second data frame to comprise the data from the first data frame, a MAC address of a fourth wireless device, and the MAC address of the third wireless device; and
configure the first wireless device to transmit the second data frame.

2. The apparatus of claim 1 wherein the processing circuitry is further configured to:
determine whether the third wireless device is the immediate neighbor based on a neighbor table, the neighbor table indicating media access control (MAC) addresses and received signal strength indicators (RSSIs) of wireless devices from which the first wireless device has received a frame.

3. The apparatus of claim 1 wherein the processing circuitry is further configured to:
determine the fourth wireless device based on the neighbor table, wherein the neighbor table indicates that the fourth wireless device is a neighbor of the third wireless device.

4. The apparatus of claim 1 wherein the processing circuitry is further configured to:
determine a common availability window for the first wireless device and the fourth wireless device or the third wireless device based on a received availability window from the third wireless device or the fourth wireless device and availability windows of the first wireless device, the common availability window comprising a channel and time when both the first wireless device and the third wireless device or the fourth wireless device are available to transmit and receive on the channel.

5. The apparatus of claim 1 wherein the configure the first wireless device to transmit the action frame further comprises configure the first wireless device to transmit the action frame on a channel, wherein the channel is channel 6 in the 2.4 GHz band, channel 33 in the 5 GHz band, or a channel in the 6 GHz band.

6. The apparatus of claim 5 wherein before the configure the first wireless device to transmit the action frame, the processing circuitry is further configured to:
contend for the channel during a discovery window; and
gain access to the channel.

7. The apparatus of claim 6 further comprising:
decode a synchronization beacon from a fifth wireless device, the synchronization beacon comprising an indication of a time of a clock.

8. The apparatus of claim 7 further comprising:
determining the discovery window based on the time of the clock.

9. The apparatus of claim 8 wherein the fifth wireless device is a master node connected to wide area network (WAN) or the fifth wireless device is a repeater node repeating a synchronization beacon from the master node.

10. The apparatus of claim 9 wherein the synchronization beacon is a first synchronization beacon, and wherein the processing circuitry is further configured to:
determine based on a neighbor table whether to act as a repeater node; and
in response to a determination to act as a repeater node, encode a second synchronization beacon comprising a second indication of the time of the clock, wherein the second indication of the time of the clock is based on the first indication of the time of the clock.

11. The apparatus of claim 1 wherein the processing circuitry is further configured to:
determine a link local address for the first wireless device; and
encode the action frame to comprise the link local address as a transmitter address.

12. The apparatus of claim 11 wherein the link local address is determined based on a 48-bit media access control (MAC) address of the first wireless device and addresses reserved for link local addressing.

13. The apparatus of claim 1 wherein the action frame is a first action frame, and wherein the processing circuitry is further configured to:
encode a second action comprising a synchronization tree, the synchronization tree indicating a path from the first wireless device to a master node, wherein the synchronization tree is encoded using a type, a length, and a value format; and
configure the first wireless device to transmit the second action frame.

14. The apparatus of claim 1 wherein the action frame is a first action frame and wherein the processing circuitry is further configured to:
in response to a determination that the first wireless device has access to a wide area network (WAN), encode a second action frame, the second action frame comprising a subfield indicting it is a service discover frame and a subfield to indicate that the first wireless device provides an internet gateway (GW) service, configure the first wireless device to transmit the second action frame, and encode a synchronization beacon comprising an indication of a time of a clock of the first wireless device.

15. The apparatus of claim 14 wherein the processing circuitry is further configured to:
configure the first wireless device to transmit the synchronization beacon at a time based on a discovery window, wherein the discovery window begins at the transmission of the synchronization beacon.

16. The apparatus of claim 1, wherein the first wireless device is an access point (AP) or a non-AP station (STA), and wherein the first wireless device is configured to operate in accordance with Institute of Electrical and Electronic Engineers (IEEE) 802.11, and wherein the action frame is a physical (PHY) protocol data unit (PPDU).

17. A non-transitory computer-readable storage medium that stores instructions for execution by one or more processors of an apparatus of a first wireless device, the instructions to configure the one or more processors to:
encode an action frame, the action frame comprising a subfield indicating it is a service discovery frame, and a subfield to indicate that the first wireless device provides a bridge service;
configure the first wireless device to transmit the action frame;
decode a first data frame from a second wireless device, the data frame indicating a destination address of a third wireless device;
in response to the third wireless device being an immediate neighbor of the first wireless device, encode a second data frame comprising the data from the first data frame and an media access control (MAC) address of the third wireless device as the receiver address of the data frame;
in response to the third wireless device not being an immediate neighbor of the first wireless device, encode the second data frame to comprise the data from the first data frame, a MAC address of a fourth wireless device, and the MAC address of the third wireless device; and
configure the first wireless device to transmit the second data frame.

18. The non-transitory computer-readable storage medium of claim 17, wherein the instruction further configured the one or more processors to:
determine whether the third wireless device is the immediate neighbor based on a neighbor table, the neighbor table indicating media access control (MAC) addresses and received signal strength indicators (RSSIs) of wireless devices from which the first wireless device has received a frame.

19. A method performed by an apparatus of a first wireless, the method comprising:
encoding an action frame, the action frame comprising a subfield indicating it is a service discovery frame, and a subfield to indicate that the first wireless device provides a bridge service;
configuring the first wireless device to transmit the action frame;
decoding a first data frame from a second wireless device, the data frame indicating a destination address of a third wireless device;
in response to the third wireless device being an immediate neighbor of the first wireless device, encoding a second data frame comprising the data from the first data frame and an media access control (MAC) address of the third wireless device as the receiver address of the data frame;
in response to the third wireless device not being an immediate neighbor of the first wireless device, encoding the second data frame to comprise the data from the first data frame, a MAC address of a fourth wireless device, and the MAC address of the third wireless device; and
configuring the first wireless device to transmit the second data frame.

20. The method of claim 19 further comprising:
determining whether the third wireless device is the immediate neighbor based on a neighbor table, the neighbor table indicating media access control (MAC) addresses and received signal strength indicators (RSSIs) of wireless devices from which the first wireless device has received a frame.
